(19) United States
(12) Patent Application Publication
(10) Pub. No.: US 2006/0020718 A1
(43) Pub. Date: Jan. 26, 2006

(54) Resource sharing apparatus, systems, and methods

(76) Inventors: Nicholas E. Duresky, San Jose, CA (US); Sreenath Kurupati, Santa Clara, CA (US)

Correspondence Address: Schwegman, Lundberg, Woessner & Kluth, P.A., P.O. Box 2938, Minneapolis, MN, 55402, US

(21) Appl. No.: 10/880,153

(22) Filed: Jun. 28, 2004

(51) Int. Cl. G06F 3/00

(52) U.S. Cl. 710/11

(57) ABSTRACT

An apparatus and a system, as well as a method and article, may operate to interchangeably store audio data associated with an audio interface protocol selected from a plurality of audio interface protocols in a polymorphic memory structure capable of being coupled to a common digital input-output interface.

### TECHNICAL FIELD

Various embodiments described herein relate to information processing generally, including apparatus, systems, and methods used to process data and share resources.

### BACKGROUND INFORMATION

A data processing system may be capable of processing multiple audio interface protocols such as an International Electrotechnical Commission (IEC) 60958 (also referred to as Sony/Philips Digital Interface SPDIF or S/PDIF) protocol, an inter-IC sound (I²S) bus specification, and/or other protocols. Multiple audio interface protocols may require multiple instances of identical resources, such as first-in, first-out (FIFO) memories and gate buffers used by each, resulting in costly duplication.

For more information regarding IEC 60958 standards, please refer to “IEC 60958-1 Digital Audio Interface—Part 1, Edition 2: 2004”, “IEC 60958-3 Digital Audio Interface—Part 3, Edition 2: 2003”, and “IEC 60958-4 Digital Audio Interface—Part 4, Edition 2: 2003” prepared by Technical Area 4, Digital System Interfaces, IEC Technical Committee 100: Audio, Video and Multimedia Systems and Equipment. For more information regarding the I²S bus, see Philips Semiconductors publication “I²S Bus Specification” (February 1986, revised Jun. 5, 1996) at http://www.semiconductors.philips.com/acrobat/various/I2SBUS.pdf.

### BRIEF DESCRIPTION OF THE DRAWINGS

FIG. 1 is a block diagram of apparatus and systems according to various embodiments of the invention;

FIG. 2 is a flow diagram illustrating several methods according to various embodiments of the invention; and

FIG. 3 is a block diagram of an article according to various embodiments of the invention.

### DETAILED DESCRIPTION

In some embodiments, any one of multiple audio interface protocols may utilize common memory elements such as registers, FIFOs, bus interface logic, and/or interrupt logic when multiple protocols are not simultaneously active. In some embodiments, audio data may be steered between elements common to multiple audio interface protocols and protocol specific elements by control logic whose state may be determined by a protocol mode indicator. For the purposes of this document, the following definitions may be observed.

“Audio data” may include a binary representation of sounds between about 0 hertz and about 120 kilohertz.

An “audio interface protocol” may include audio data formatted according to a specification, such as I²S, or a standard, such as IEC 60958.

A “bus interface” may include drivers and/or receivers to transmit and/or receive system bus signals to and/or from a polymorphic memory structure with appropriate drive current and/or impedance.

The term “common”, as used in conjunction with a “common receive FIFO”, a “common interrupt”, etc. may refer to a resource (e.g. FIFO, interrupt) that can be shared between a plurality of different audio interface protocols.

“Control logic” may include Boolean functions required to gate audio data to or from one of a plurality of formatting modules, or to control data writes to a FIFO or reads from a FIFO based upon data-control-status register values.

“Data-control-status registers” may include memory elements capable of storing any combination of audio data, interrupt state, audio data direction information, and/or audio interface protocol type information.

A “digital input-output interface” may include drivers and/or receivers (and/or clocks, according to the audio interface protocol) to transmit and/or receive audio data from a polymorphic memory structure with appropriate drive current and impedance.

A “FIFO” may include any first-in, first-out memory element capable of storing data serially and/or in parallel and releasing data by reading in the order that it was stored.

A “formatting module” may include a structure capable of translating audio data back and forth between a common data format and one of a plurality of audio interface protocols, including but not limited to I²S and/or SPDIF, and/or optionally may include serial to parallel or parallel to serial conversion.

“High-definition television” (HDTV) may include a system for transmitting a television signal with substantially higher definition than the National Television Standards Committee (NTSC) standard. For more information regarding the NTSC standard, see Society of Motion Picture and Television Engineers, “Television—Composite Analog Video Signal—NTSC for Studio Applications,” SMPTE-170M, 1994. For more information about HDTV standards, see e.g. “SMPTE 274M (1995), Standard for Television, 1920×1080 Scanning and Interface”, Society of Motion Picture and Television Engineers, White Plains, N.Y., and “SMPTE 296M (1997), Standard for Television, 1280×720 Scanning, Analog and Digital Representation, and Analog Interface”, Society of Motion Picture and Television Engineers, White Plains, N.Y.

The term “interchangeably store” may include transferring data to or from a memory structure whose generality of operation supports interaction with a plurality of audio interface protocols.

A “polymorphic memory structure” may include any set of structural elements that may be utilized by one of a plurality of different audio interface protocols while not being utilized by another audio interface protocol.

The acronym “SPDIF” or “S/PDIF” may include audio data formatted according to the IEC 60958 standard.

A “status indicator” may mean any mechanism (e.g., a circuit, an object, a software or hardware flag, a register, an interrupt, etc.) that provides an indication or information about a level of processing resource usage, including, but not limited to: a buffer/storage fill level, a forecast of buffer/storage fill velocity, a prior buffer/storage fill acceleration rate, a level of congestion in a network or at a port, an operating frequency, a data transport speed, a data acquisition speed, a forecast change in data acquisition speed, a number of write operations over time, a prior number of read operations over time, etc. For example, a first amount of buffer fill (e.g., 50%) may be compared against a second amount of buffer fill (e.g., 75%) to determine that the second buffer is more fully utilized at a particular instant than the first buffer. Another example includes an alarm indicating that a processing element is forecast to use 110% of its allocated energy budget if a current resource allocation is maintained.

A “system bus” may include any combination of data, control, and/or interrupt signals used by system structures including polymorphic memory structures to communicate among themselves.

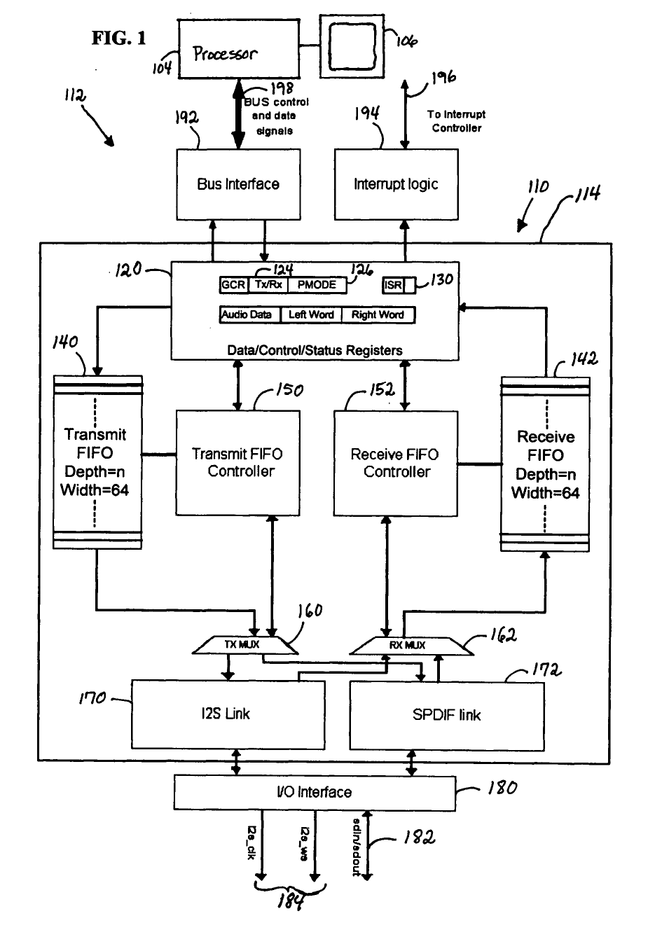

FIG. 1 is a block diagram of an apparatus 110 and a system 112 according to various embodiments the invention, each of which may operate in the manner described above. For example an apparatus 110 may include a polymorphic memory structure 114. The polymorphic memory structure 114 may include but is not limited to a set of data-control-status registers 120, a transmit FIFO 140, a receive FIFO 142, and one or more formatting modules 170, 172. For example, the formatting module 170 may comprise one or more I²S formatting modules, and the formatting module 172 may comprise one or more SPDIF formatting modules. The formatting modules 170, 172 may comprise formatting modules corresponding to audio interface protocols other than I²S and/or SPDIF.

The polymorphic memory structure 114 may include control logic comprising a transmit FIFO controller 150, a receive FIFO controller 152, a transmit multiplexer 160, and/or a receive multiplexer 162. The polymorphic memory structure 114 may interchangeably store audio data 182 associated with an audio interface protocol selected from a plurality of audio interface protocols and/or may include a common digital input-output interface 180 coupled to the polymorphic memory structure 114. The audio data 182 and/or other signals 184 associated with the common digital input-output interface 180 may be formatting according to protocols embodied by the formatting module 170 and/or 172 selected at a time when the audio data 182 and/or other signals 184 are active at the common digital input-output interface 180.

It should be noted that I²S and/or SPDIF are merely examples of audio interface protocols that may share resources according to various embodiments of the apparatus 110. Thus, the I²S formatting module 170 and/or SPDIF formatting module 172 are merely examples of formatting modules that may utilize shared resources according to various embodiments of the apparatus 110. Therefore, embodiments including formatting modules utilizing other audio interface protocols may be realized.

Some embodiments may include a common receive FIFO memory 142 coupled to common digital input-output interface 180 to store audio data. In some embodiments, a common transmit FIFO memory 140 coupled to a common digital input-output interface 180 and/or a common bus interface 192 may store audio data 182. Some embodiments may include a plurality of registers 120 including a common interrupt status register 130 associated with audio data 182.

In some embodiments, a protocol mode indication may be implemented with at least one protocol mode bit 126 included in the plurality of registers 120, possibly to indicate the audio interface protocol type. In some embodiments the protocol mode indication may direct a transmit FIFO controller 150 to act upon a transmit multiplexer 160 to gate audio data out of the transmit FIFO 140 to one of a plurality of protocol-specific formatting modules including but not limited to the I²S formatting module 170 and/or the SPDIF formatting module 172. In some embodiments the protocol mode indication may direct a receive FIFO controller 152 to act upon a receive multiplexer 162 to gate audio data from one of a plurality of protocol specific formatting modules including, but not limited to, an I²S formatting module 170 and/or an SPDIF formatting module 172, to a receive FIFO 142. In some embodiments the contents of the interrupt status register 130 may cause the interrupt logic 194 to generate an interrupt 196. Other embodiments may be realized.

For example, a system 112 may include an apparatus 110, similar to or identical to that previously described, as well as a display 106, a processor 104 coupled to the display, a common bus interface 192 coupled to the processor 104 by a system bus 198, and/or one or more polymorphic memory structures 114 to interchangeably store audio data 182 associated with an audio interface protocol selected from a plurality of audio interface protocols. Multiple instances of the polymorphic memory structure 114 may be coupled to the common bus interface 192 and/or to a common digital input-output interface 180. For example, a second polymorphic memory structure 114 to interchangeably store second audio data 182 associated with a second audio interface protocol selected from the plurality of audio interface protocols, wherein the second polymorphic memory structure 114 is coupled to the common bus interface, may be incorporated. Some embodiments may utilize one or more audio interface protocols including but not limited to the I²S protocol, the IEC 60958-1 protocol, the IEC 60958-3 protocol, and/or the IEC 60958-4 protocol. Some embodiments may also include a plurality of registers 120 including a flow direction indicator 124 associated with the audio data 182. Some system embodiments may include an I²S formatting module 170, an SPDIF formatting module 172, and/or a formatting module other than I²S or SPDIF to format the audio data according to a selected audio interface protocol, as well as a high-definition television (HDTV) display.

The apparatus 110, system 112, polymorphic memory structure 114, data-control-status registers 120, formatting modules 170, 172, transmit FIFO controller 150, receive FIFO controller 152, audio data 182, digital input-output interface 180, transmit FIFO memory 140, receive FIFO memory 142, bus interface 192, interrupt status register 130, interrupt logic 194, interrupt 196, protocol mode bit 126, transmit multiplexer 160, receive multiplexer 162, display 106, processor 104, system bus 198, and flow direction indicator 124, may all be characterized as “modules” herein. Such modules may include hardware circuitry, and/or one or more processors and/or memory circuits, software program modules, including objects and collections of objects, and/or firmware, and combinations thereof, as desired by the architect of the apparatus 110 and systems 112, and as appropriate for particular implementations of various embodiments of the invention.

It should also be understood that the apparatus and systems of various embodiments can be used in applications other than for processing audio data and thus various embodiments are not to be so limited. The illustrations of apparatus 110 and systems 112 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, personal digital assistants (PDAs), workstations, radios, video players, vehicles, and others.

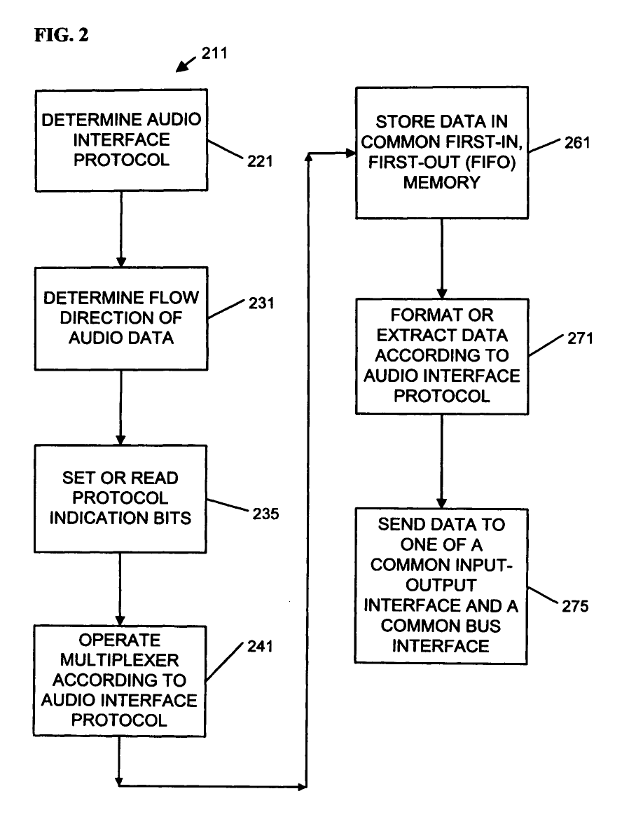

FIG. 2 is a flow chart illustrating several methods according to various embodiments of the invention. In some embodiments, a method 211 may (optionally) begin with determining the audio interface protocol associated with selected audio data from a plurality of audio interface protocols including at least one of an I²S protocol, an IEC 60958-1 protocol, an IEC 60958-3 protocol, and/or an IEC 60958-4 protocol at block 221. The method 211 may continue with determining a flow direction associated with the audio data at block 231.

The method 211 may also include reading or setting a protocol mode indication, perhaps including one or more protocol mode bits to indicate the audio interface protocol, at block 235. In some embodiments, a multiplexer may be operated according to the protocol mode indication at block 241.

Some embodiments may include storing audio data in a common receive FIFO memory to send to a common bus interface, and/or storing audio data in a common transmit FIFO memory to send to a common digital input-output interface at block 261. Some embodiments may include formatting and/or extracting audio data according to the audio interface protocol at block 271. In many embodiments, audio data may be sent to either a common digital input-output interface and/or a common bus interface at block 275.

Some embodiments may also include methods of asserting a common interrupt associated with the audio data (e.g., at block 235), storing the audio data serially in the polymorphic memory structure to send to a common bus interface (e.g., at blocks 261 and 275), and/or storing the audio data in a polymorphic memory structure as separated left and right channel information (e.g., at block 261).

It should be noted that the methods described herein do not have to be executed in the order described, or in any particular order. Moreover, various activities described with respect to the methods identified herein can be executed in serial, parallel, simultaneous, or iterative fashion. For the purposes of this document, the terms “information” and “data” may be used interchangeably. Information, including parameters, commands, operands, and other data, including data in various formats (e.g., time division, multiple access) and of various types (e.g., binary, alphanumeric, audio, video), can be sent and received in the form of one or more carrier waves.

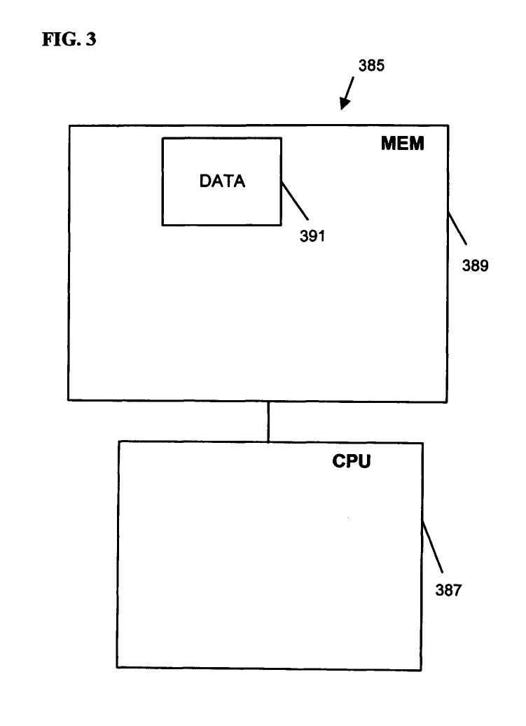

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including remote procedure calls. The teachings of various embodiments are not limited to any particular programming language or environment. Thus, other embodiments may be realized, as shown in FIG. 3.

FIG. 3 is a block diagram of an article 385 according to various embodiments, such as a computer, a memory system, a magnetic or optical disk, some other storage device, and/or any type of electronic device or system. The article 385 may comprise a processor 387 coupled to a machine-accessible medium such as a memory 389 (e.g., a memory including an electrical, optical, or electromagnetic conductor) having associated information 391 (e.g., computer program instructions, and/or other data) which, when accessed, results in a machine (e.g., the processor 387) performing such actions as interchangeably storing audio data associated with an audio interface protocol selected from a plurality of audio interface protocols in a polymorphic memory structure capable of being coupled to a common digital input-output interface.

Other activities may include determining the audio interface protocol and/or a flow direction associated with the audio data. In some embodiments, further activities may include asserting a common interrupt associated with the audio data as well as storing the audio data serially in the polymorphic memory structure to send to a common bus interface. Other activities may include storing the audio data in a polymorphic memory structure as separated left and right channel information.

Implementing the apparatus, systems, and methods described herein may result in conserving significant hardware resources including but not limited to die size and/or input-output pins. Hardware resources may be conserved in proportion to the number of supported audio interface protocols.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
interchangeably storing audio data associated with an audio interface protocol selected from a plurality of audio interface protocols in a polymorphic memory structure capable of being coupled to a common digital input-output interface.

2. The method of claim 1, wherein the plurality of audio interface protocols include at least one of an inter-IC sound bus (I²S) protocol, an International Electrotechnical Commission (IEC) 60958-1 protocol, an IEC 60958-2 protocol, and an IEC 60958-3 protocol.

3. The method of claim 1, further including:
storing the audio data in a common receive first-in, first-out memory to send to a common bus interface.

4. The method of claim 1, further including:
storing the audio data in a common transmit first-in, first-out memory to send to the common digital input-output interface.

5. The method of claim 1, further including:
operating a multiplexer according to a protocol mode indication associated with the audio interface protocol.

6. The method of claim 5, wherein the protocol mode indication includes at least one bit to indicate the audio interface protocol.

7. The method of claim 1, further including:
formatting the audio data according to the audio interface protocol.

8. The method of claim 7, further including:
extracting the audio data from information formatted according to the audio interface protocol.

9. The method of claim 1, further including:
determining the audio interface protocol.

10. The method of claim 1, further including:
determining a flow direction associated with the audio data.

11. An article including a machine-accessible medium having associated information, wherein the information, when accessed, results in a machine performing:
interchangeably storing audio data associated with an audio interface protocol selected from a plurality of audio interface protocols in a polymorphic memory structure capable of being coupled to a common digital input-output interface.

12. The article of claim 11, wherein the information, when accessed, results in a machine performing:
determining the audio interface protocol and a flow direction associated with the audio data.

13. The article of claim 11, wherein the information, when accessed, results in a machine performing:
asserting a common interrupt associated with the audio data.

14. The article of claim 11, wherein the information, when accessed, results in a machine performing:
storing the audio data serially in the polymorphic memory structure to send to a common bus interface.

15. The article of claim 11, wherein the information, when accessed, results in a machine performing:
storing the audio data in a polymorphic memory structure as separated left and right channel information.

16. An apparatus, including:
a polymorphic memory structure to interchangeably store audio data associated with an audio interface protocol selected from a plurality of audio interface protocols; and
a common digital input-output interface coupled to the polymorphic memory structure.

17. The apparatus of claim 16, further including:
a common receive first-in, first-out memory to store the audio data and coupled to the common digital input-output interface.

18. The apparatus of claim 17, further including:
a common transmit first-in, first-out memory to store the audio data and coupled to the common digital input-output interface and a common bus interface.

19. The apparatus of claim 16, further including:
a plurality of registers including a common interrupt status register associated with the audio data.

20. The apparatus of claim 19, further including:
at least one protocol mode bit included in the plurality of registers to indicate the audio interface protocol.

21. A system, including:
a display;
a processor coupled to the display;
a common bus interface coupled to the processor;
a first polymorphic memory structure to interchangeably store audio data associated with an audio interface protocol selected from a plurality of audio interface protocols, wherein the polymorphic memory structure is coupled to the common bus interface; and
a common digital input-output interface coupled to the polymorphic memory structure.

22. The system of claim 21, wherein the plurality of audio interface protocols include at least one of an inter-IC sound bus (I²S) protocol, an International Electrotechnical Commission (IEC) 60958-1 protocol, an IEC 60958-3 protocol, and an IEC 60958-4 protocol.

23. The system of claim 21, further including:
a plurality of registers including a flow direction indicator associated with the audio data.

24. The system of claim 21, further including:
a formatting module to format the audio data according to the audio interface protocol.

25. The system of claim 21, wherein the display comprises a high-definition television display.

26. The system of claim 21, further including:
a second polymorphic memory structure to interchangeably store second audio data associated with a second audio interface protocol selected from the plurality of audio interface protocols, wherein the second polymorphic memory structure is coupled to the common bus interface.
